(19) United States
(12) Patent Application Publication
(10) Pub. No.: US 2007/0172620 A1
(43) Pub. Date: Jul. 26, 2007

(54) TEAR PROPAGATION-RESISTANT ADHESIVE TAPE

(75) Inventors: ILSE RODEWALD, HAMBURG (DE); PETRA YUN, HAMBURG (DE); THOMAS HECK, Charlotte, NC (US)

Correspondence Address: NORRIS, MCLAUGHLIN & MARCUS, PA, 875 THIRD AVENUE, 18TH FLOOR, NEW YORK, NY, 10022, US

(73) Assignee: TESA AKTIENGESELLSCHAFT, HAMBURG (DE)

(21) Appl. No.: 11/626,466

(22) Filed: Jan. 24, 2007

(30) Foreign Application Priority Data
Jan. 25, 2006 (DE) 10 2006 003 756.1

(51) Int. Cl. B32B 33/00; G09F 3/00

(52) U.S. Cl. 428/40.1; 428/136; 428/43

(57) ABSTRACT

Adhesive tape having a backing material applied to at least one side of which is an adhesive, in particular a pressure-sensitive adhesive, the backing material being composed of at least one film, characterized in that the film has at least one score extending in the machine direction of the adhesive tape.

The invention relates to an adhesive tape having a backing material applied to at least one side of which is an adhesive, the backing material being composed of at least one film.

Tear propagation resistance in adhesive tapes poses a problem on which work is continually ongoing to find a solution.

It is known, furthermore, that films which are monoaxially oriented for the purpose of achieving a high machine-direction tensile strength typically have the drawback of a drastically reduced tear propagation resistance.

Solutions for increasing the tear propagation resistance of adhesive tapes are based on a variety of approaches, an example being the fiber reinforcement of the backing material. Typical tapes include what are called “filament” adhesive tapes with unidirectional lengthwise nonwoven scrims or bidirectional woven or nonwoven scrims, composed of twisted or tangled yarns. These yarns may be composed, for example, of continuous synthetic fibers or else of natural fibers. The fibers in this kind of adhesive tape are often held together to form locally fixed fiber or filament bundles.

The fibers introduced in this way, as well as the function of increasing the tear propagation resistance, may take over a variable component of the tensile strength.

Another solution is, for example, an oriented film composed of at least two coextruded layers of different composition, with an irregular internal structure, as set out in DE 199 55 610 A1. In this arrangement, the thickness of one of these layers varies in inverse proportion to the second layer across the width of the adhesive tape; the overall thickness is constant. As a result of the different mechanical properties of the layers, a tear which begins in the cross direction is diverted into the machine direction. An obvious drawback of the embodiment disclosed therein, however, is the costly and complicated machinery needed to produce this type of film.

A further means of increasing the tear propagation resistance is, for example, a reinforcing rib structure, as is disclosed in EP 0 411 830 A1, EP 0 343 896 A1, U.S. Pat. No. 5,145,544 A and U.S. Pat. No. 5,173,141 A. This variant too has a variety of drawbacks, which have already been set out adequately in DE 199 55 610 A1.

It is an object of the invention to provide an adhesive tape which has a very high tear propagation resistance in cross direction (cd) and a very high tensile strength in machine direction (md).

This object is achieved by means of an adhesive tape as set out in claim 1. The dependent claims provide developments of the adhesive tape of the invention, and also uses thereof.

The invention accordingly provides an adhesive tape having a backing material applied to at least one side of which is an adhesive, in particular a pressure-sensitive adhesive, the backing material being composed of at least one film and which has at least one score extending in the machine direction of the adhesive tape, thereby producing at least one further edge within the film, in addition to the two side edges.

In one first preferred embodiment of the invention the score extends over at least one fifth of the total thickness of the backing material.

With further preference the score begins on the surface of the backing material to which the adhesive has been applied, so that the exposed surface of the backing material is undamaged.

It is preferred if the score begins on the surface of the backing material to which the adhesive has been applied, so that the exposed surface of the backing material is undamaged.

With further preference the score is made as a slit extending over the entire thickness of the backing material.

The score or the slit (or, if two or more are present, the scores or slits) can in each case be made as a continuous or as a broken line, the latter broken preferably at regular intervals.

Also possible, of course, is any desired mix of scoring and slitting in the film. Additionally, each score itself may in sections penetrate completely through the film of the backing material; that is, it may, in sections, undergo transition to a slit.

In that case, in the film, there may be scores and slits present in alternation in any desired arrangement.

The film is selected according to mechanical properties such as tensile strength, stiffness, and others.

Material which can be used for the film includes all of the film materials known to the skilled person.

Preference is given, for example, to BOPP, MOPP, PP, PE, PET, PA, PU, PVC or polyesters. Generally speaking it is possible to use polyolefins, copolymers of ethylene and polar monomers such as styrene, vinyl acetate, methyl methacrylate, butyl acrylate or acrylic acid, homopolymers such as HDPE, LDPE, MDPE or copolymers of ethylene and a further olefin such as propene, butene, hexene or octene (for example LLDPE, VLLDPE) or polypropylenes such as, for example, polypropylene homopolymers, random polypropylene copolymers or polypropylene block copolymers.

Particular preference is given, however, to relatively stiff, high-tensile backings such as PET, MOPP and U-PVC.

The film thicknesses may range advantageously from 5 to 50 pm. Even greater thicknesses may be employed.

The film may further serve as protection against chemicals or as a barrier film, by application of a metallic layer, for example. It may ensure the UV protection of the adhesive, by virtue of the incorporation of UV absorbers. It may determine the optical properties, such as gloss or color, through the use, for example, of a colored film.

If the adhesive tape of the invention possessing at least one score is damaged at one of the two side edges, the resulting tear propagates crosswise with respect to the machine direction only until it meets this score. At that point the tear is diverted into the longitudinal direction relative to the adhesive tape. In other words, as a result of the scoring, the backing is fractionated in the longitudinal direction, the end of a fraction being marked by a score, as a tear stopper, or by a side edge of the adhesive tape.

These fractions are called strips in the text below.

In one preferred embodiment of the backing material two marginal strips are scored into the backing. The width of the marginal strips amounts to not more than one third of the overall adhesive tape width. The marginal strips are for protection against preliminarily calculable side-edge damage with a maximum depth of penetration.

The strips may have different widths. It is particularly preferred, however, for all of the strips to have the same width. As a consequence of the production process, the two outer strips may have deviating widths.

In order to provide additional inner edges by means of the strips, at least two scores or slits are envisaged. In that case the score edge can be disposed centrally, so that the two strips are of equal width. It is also possible, however, to produce “asymmetrical” films, in which one strip is wider than the second strip and in which, in particular, the tear propagation propensity is reduced from the side of the narrower strip.

The number of strips can be increased in principle arbitrarily, the upper limit on the number of strips being governed by the width of the adhesive tape and the strip width. Thus it is possible, for example, also to produce symmetrical or asymmetrical slitted films having three strips, examples being those in which one inner edge in each case is provided as a tear boundary in the vicinity of the adhesive tape's edges.

The width of the strips is with particular preference between 1 and 4 mm, very preferably about 2 mm. Particularly in the case of strips which have a low width in relation to the width of the adhesive tape, an equal strip width is of advantage.

Preferred embodiments are those in which there is a score across the width of the adhesive tape. Moreover, two slits, preferably disposed symmetrically, have proved to be advantageous, this symmetrical disposition being such that one each of these two scores is disposed close to one of the two side edges of the backing material. Thus a particularly advantageous adhesive tape, with a width of 15 mm, is one in which there is a film with a total of three strips having, from left to right, a width of 4/7/4 mm. With a width of 19 mm, a 4/11/4 arrangement is preferably chosen.

This allows the production of adhesive tapes which in terms of their thickness are situated well below prior-art adhesive tapes for corresponding fields of use. For instance it is possible to produce adhesive tapes having a thickness of in particular 50 to 150 pm, with particular preference of below 100 pm, with very particular preference of below 80 pm, which, surprisingly, have a comparable tear strength.

The strength of the backing material is preferably at least 250 N/mm², in particular 5 300 N/mm².

The adhesive tape has a considerable tensile strength and also tear propagation resistance in cross direction. Furthermore, it is of only minimal extensibility, and achieves all of this with a very low thickness.

The slitted backing may be furnished with a release layer, through which it is possible to exert a decisive influence over the surface properties such as friction or release effect in the case of single-sided adhesive-coated adhesive tapes.

The adhesive of the adhesive tapes of the invention may be a (self-)adhesive from the group of the natural rubbers or the synthetic rubbers, or composed of any desired blend of natural rubbers and/or synthetic rubbers, it being possible for the natural rubber or rubbers to be selected in principle from all available grades, such as, for example, crepe, RSS, ADS, TSR or CV grades, depending on required purity and viscosity level, and for the synthetic rubber or rubbers to be selected from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible to improve the processing properties of the rubbers by adding thermoplastic elastomers with a weight fraction of 10% to 50% by weight, based on the overall elastomer fraction.

Representatives that may be mentioned at this point include in particular the especially compatible styrene-isoprene-styrene (SIS) and styrene-butadiene-styrene (SBS) grades.

In addition a 100% styrene-isoprene-styrene (SIS) system has proved to be suitable.

Tackifying resins which can be used include, without exception, all tackifier resins already known and described in the literature. Representatives that may be mentioned include the rosins, their disproportionated, hydrogenated, polymerized, and esterified derivatives and salts, the aliphatic and aromatic hydrocarbon resins, terpene resins and terpenephenolic resins. Any desired combinations of these and further resins may be used in order to adjust the properties of the resultant adhesive in accordance with requirements. Express reference may be made to the exposition of the state of knowledge in the “Handbook of Pressure Sensitive Adhesive Technology” by Donatas Satas (van Nostrand, 1989).

Crosslinking is advantageous for improving the removability of the adhesive tape after the application, and may take place thermally or by irradiation with UV light or electron beams.

For the purpose of thermally induced chemical crosslinking it is possible to employ all known thermally activable chemical crosslinkers, such as accelerated sulfur systems or sulfur donor systems, isocyanate systems, reactive melamine resins, formaldehyde resins and (optionally halogenated) phenol-formaldehyde resins and/or reactive phenolic resin crosslinking systems or diisocyanate crosslinking systems with the corresponding activators, epoxidized polyester resins and acrylate resins, and also combinations of these.

The crosslinkers are activated preferably at temperatures above 50° C., in particular at temperatures of 100° C. to 160° C., very preferably at temperatures of 110° C. to 140° C.

The thermal excitation of the crosslinkers may also take place by means of IR rays or high-energy alternating fields.

An adhesive which is suitable is one based on acrylate hotmelt, on solvent or on water, it being possible for the first of these to have a K value of at least 20, in particular more than 30, and it being obtainable by concentrating a solution of such an adhesive to give a system which can be processed as a hotmelt.

Concentration may take place in appropriately equipped tanks or extruders; particularly in the case of accompanying devolatilization, a devolatilizing extruder is preferred.

One such adhesive is set out in DE 43 13 008 A1, whose content is hereby incorporated by reference to be part of this disclosure and invention.

Alternatively the acrylate hotmelt-based adhesive can be chemically crosslinked.

In one further embodiment the self-adhesives used are copolymers of (meth)acrylic acid and the esters thereof having 1 to 25 C atoms, maleic, fumaric and/or itaconic acid and/or their esters, substituted (meth)acrylamides, maleic anhydride and other vinyl compounds, such as vinyl esters, especially vinyl acetate, vinyl alcohols and/or vinyl ethers.

The residual solvent content ought to be below 1% by weight.

One adhesive which is found to be particularly suitable is a low molecular mass acrylate hotmelt pressure-sensitive adhesive of the kind carried under the name acResin UV or Acronal®, especially Acronal® DS3458, by BASF. This low-K-value adhesive acquires its application-compatible properties by means of a concluding, radiation-induced chemical crosslinking.

Finally it may be mentioned that polyurethane-based adhesives are also suitable.

A single-sided adhesive tape may be used with particular advantage, the application of adhesive being preferably between 15 to 60 g/m², with further preference between 20 to 30 g/m².

The adhesive tape, finally, may have a liner material, with which the one or two layers of adhesive are lined until use. Suitable liner materials include all of the materials listed in detail above.

Preference, however, is given to using a non-fluffing material such as a polymeric film or a well-sized, long-fibred paper.

The scoring and/or slitting of the film may take place at various points in the production operation. The backing may be slit, partly slit or scored before or after the adhesive coating operation. For these purposes it is possible to use all commercially customary cutting, slitting or punching processes which possess the requisite precision for scoring and/or are suitable for introducing slits with such low spacings.

By way of example it is possible for this purpose, after the coating with adhesive, to use the process of rotary diecutting. In this case an adhesive having the properties stated above is produced and by means of rotary diecutting is not only scored but at the same time converted. The adhesive tape, with the adhesive side upwards, is guided past beneath the diecutting shaft, which has the appropriate working width. As it passes beneath the shaft, slits of different depths are made in the matrix along the machine direction. Some of the slits divide the material, while others merely score it. In this way the adhesive tape in question is cut down to the desired width and at the same time the backing material is scored through the adhesive. The rotary diecutting in this case is sufficiently precise that the backing material is scored into in a precisely defined way.

This process allows the precise positioning of the scoring at the side edges of the tape, taking into account the side-edge damage to the adhesive tape that is planned in the application.

A further possibility is that of rotary diecutting prior to coating with adhesive. In that case the backing material is passed in front of one or a combination of two or more cutting shafts. In this way the backing stop is scored at uniform intervals. Moreover, like any other film backing, this backing can be subjected to further processing, and to finish with can also be converted in just the same way.

The conventional applications of adhesive tapes with tear propagation resistance encompass, for example, bundling, packing, palletizing or use similar to a tensioning belt, and are described at length in U.S. Pat. No. 2,750,315 A. They share the feature of the fixing of one or more articles to itself or themselves, to one another or to further objects. All of the applications mentioned there can be fulfilled with similar efficiency by the present invention.

Besides the applications specified above, the adhesive tape of the invention is outstandingly suitable for all functions requiring a reinforcing effect of load-bearing elements in combination or, optionally, individually with tear resistance and tear propagation resistance.

Materials which can be reinforced include, for example, those such as paper, corrugated board or solid board, preferably at exposed positions such as grips, handles and cutouts. In addition, the adhesive tape can be used as a constructional element, in order to prevent relatively heavy packages from becoming floppy.

This produces advantages such as
the upgrading of packaging for greater challenges,
a reduction in the total amount of material used, as a result of deliberate strengthening of the zones of principal loading, and
an increase in the useful life of packaging.

In contrast to the known solutions, the present invention does not require any reinforcing filaments.

The present invention is based on the observation that a lateral tear in a film backing material is held up in machine direction and diverted not only by a slit which is slit right through but also just by a slit which is scored only in the appropriate depth, so that the remaining part of the backing material is able to absorb the tension and convert it into plastic deformation. The remaining strip or strips become extended. And, under tensile strain, stiff, thin films such as MOPP or PET react immediately by tearing through as soon as the side edge is damaged. In that case it is possible for just an untidy cut or simply just a scratch to constitute damage of this kind which leads to total failure of the adhesive tape under tensile load.

As a result of the scoring of the backing materials, however, it is now possible, on the basis of the observation stated above, to insert tear stops at freely selectable intervals, which in the event of side-edge damage prevent complete tearing right through and hence prevent failure.

In the backing material there are preferably a number of slits disposed in parallel with one another. In the case of damage in the marginal region, the tear stops immediately at the scoring, in other words in the direct vicinity of the original end of the tear (the depth of damage corresponds to the ultimate depth of tear).

The invention shows that an adhesive tape having a longitudinally scored film offers the advantages of increased cross-direction tear strength and at the same time has the advantages of the film-backed adhesive tapes, namely flat and even structure and low density in conjunction with high tensile strength.

Further advantages of this invention include the fact that films are used. In contrast to filament-reinforced adhesive tapes, for example, this leads to very flat constructions of 100 pm or less for similar performance. Moreover, there are no cavities formed, as in the case of woven and nonwoven scrims, which must be filled up with adhesive. This leads to a succinct saving in terms of adhesive.

### BRIEF DESCRIPTION OF THE DRAWINGS

The figures described below are used to elucidate the invention in more detail, without any intention to restrict it unnecessarily as a result.

FIG. 1a shows the adhesive tape, looking towards the film, the scores having been made continuously;

FIG. 1b shows the adhesive tape, looking towards the film, the scores having regular breaks;

FIG. 2 shows the adhesive tape of FIG. 1a, in a section transverse to the machine direction of the adhesive tape;

FIG. 3 shows the scoring process for producing the adhesive tape; and

FIG. 4 shows the components needed for implementing the scoring process.

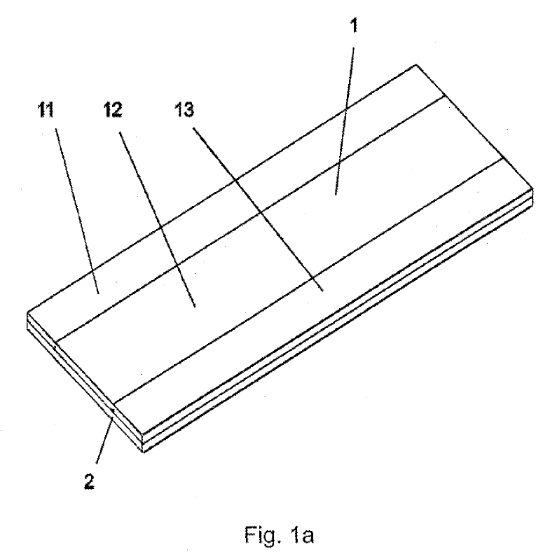

In accordance with FIG. 1 a the adhesive tape has a film 1 backing material into which two marginal strips 11 and 13 and a resultant middle strip 12 have been scored. The width of the marginal strips 11 and 13 amounts to one third of the total adhesive tape width.

Applied to the film 1 is an adhesive 2. The scores have in this case been made in the form of a continuous line.

FIG. 1 b shows an adhesive tape which is identical with that from FIG. 1a, with the exception that the scores have not been made as continuous lines but instead feature regular breaks.

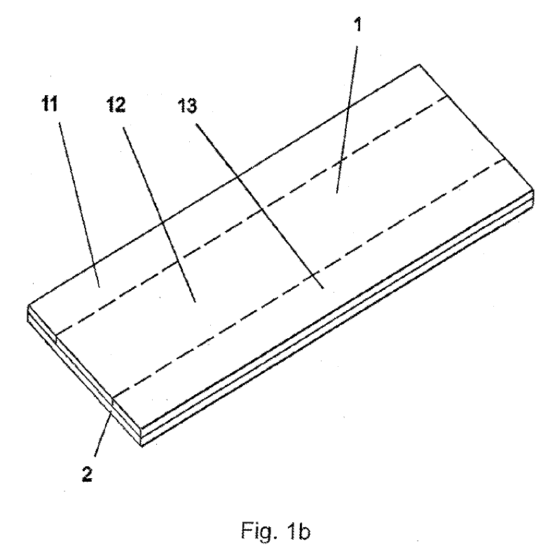

FIG. 2 shows the adhesive tape of FIG. 1 in section transverse to the machine direction of the adhesive tape. The scores which form the strips 11, 12 and 13 do not extend over the entire thickness of the film 1. The scores begin on the surface of the film 1 to which the adhesive 2 has been applied, so that the exposed surface of the backing material is undamaged.

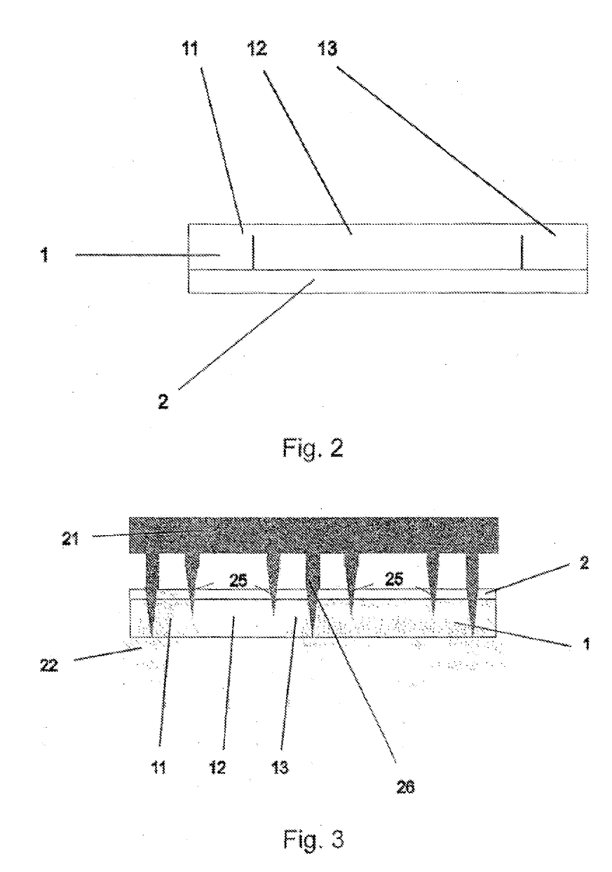

FIG. 3 shows the scoring method for producing the adhesive tape. The adhesive tape is composed of the two layers of film 1 and adhesive 2, and is guided between a rotary cutting shaft 21 and a cutting counter-cylinder 22.

Revolving cutting lines 23 (see FIG. 3) ensure on the one hand that the film 1 is slit, by virtue of the adhesive tape being only kiss-cut (25); at the same time the adhesive tape is cut to width, by virtue of the film 1 and the adhesive 2 being cut through (26).

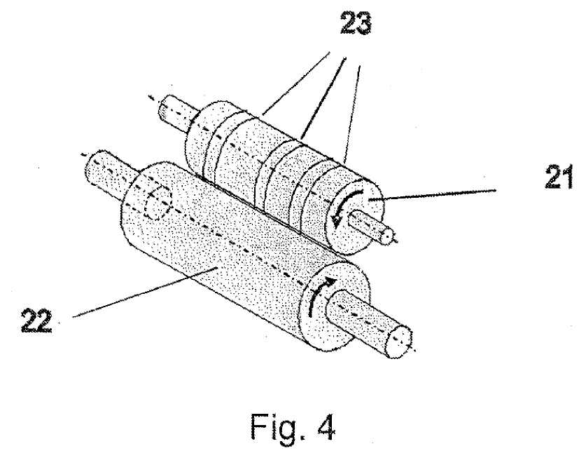

FIG. 4 shows, again, the interplay of rotary cutting shaft 21 and cutting counter-cylinder 22.

What is claimed is:

1. An adhesive tape comprising a backing material and an adhesive applied to at least one side of the backing material, the backing material being composed of at least one film, wherein the film has at least one score extending in a machine direction of the adhesive tape.

2. Adhesive tape according to claim 1, wherein the score extends over at least one fifth of a total thickness of the backing material.

3. Adhesive tape according to claim 1, wherein the score is made as a slit which extends over an entire thickness of the backing material.

4. Adhesive tape according to claim 3, wherein the score of the slit is made as a continuous or as a broken line.

5. Adhesive tape according to claim 1, wherein the backing material has two scores or slits, of which one in each case is disposed close to one of two side edges of the backing material.

6. Adhesive tape according to claim 1, wherein the score begins on a surface of the backing material to which the adhesive has been applied, so that an exposed surface of the backing material is undamaged.

7. Adhesive tape according to claim 1, wherein the film is composed of BOPP, MOPP, PP, PE, PET, PA, PU, PVC or polyester and/or has a thickness of 5 to 50 pm.

8. Adhesive tape according to claim 7, wherein the film is composed of polyesters, PET, MOPP or U-PVC.

9. Adhesive tape according to claim 1, wherein the adhesive is applied to the backing material in an amount between 15 to 60 g/m².

10. Adhesive tape according to claim 1, wherein the backing material exhibits a strength of at least 250 N/mm² for 60 pm thickness.

11. A method for bundling, packing or palletizing which comprises bundling, packing or palletizing with an adhesive tape according to claim 1.

12. A method of reinforcing paper, corrugated board or solid board comprising applying an adhesive tape according to claim 1 to said paper, corrugated board or solid board.
